(19) United States
(12) Patent Application Publication
(10) Pub. No.: US 2026/0127514 A1
(43) Pub. Date: May 7, 2026

(54) KNOW-HOW PRESENTATION METHOD

(71) Applicant: TOYOTA JIDOSHA KABUSHIKI KAISHA, Toyota-shi (JP)

(72) Inventors: Masayuki OKAMOTO, Nagoya-shi (JP); Manabu Okuyama, Nisshin-shi (JP); Naoki Yamamuro, Nagoya-shi (JP); Yasuomi Takeuchi, Toyota-shi (JP)

(73) Assignee: TOYOTA JIDOSHA KABUSHIKI KAISHA, Toyota-shi (JP)

(21) Appl. No.: 19/327,372

(22) Filed: Sep. 12, 2025

(30) Foreign Application Priority Data
Nov. 6, 2024 (JP) 2024-194744

(51) Int. Cl. G06Q 10/063; G06F 16/909; G06Q 10/10

(52) U.S. Cl. CPC G06Q 10/063; G06F 16/909; G06Q 10/10

(57) ABSTRACT

A know-how presentation method that is executed by an information processing device includes acquiring a request for output of know-how, acquiring region information, and adjusting the contents of the know-how corresponding to the request, based on the region information, and outputting of the know-how of which the contents are adjusted.

### CROSS-REFERENCE TO RELATED APPLICATION

This application claims priority to Japanese Patent Application No. 2024-194744 filed on Nov. 6, 2024. The disclosure of the above-identified application, including the specification, drawings, and claims, is incorporated by reference herein in its entirety.

### BACKGROUND

### 1. Technical Field

The present disclosure relates to a know-how presentation method.

### 2. Description of Related Art

Conventionally, technology that is related to a learning system for knowledge, know-how, and the like, has been known. For example, Japanese Patent No. 7473270 discloses technology that uses generative AI to realize providing of lectures that are tailored to the level of the audience.

### SUMMARY

Although Japanese Patent No. 7473270 discloses a learning system that utilizes machine learning such as generative AI, this does not take into consideration adjusting contents of the know-how that is presented, and so forth, in accordance with the location of the work site (head office, factory, overseas, or the like) of a user being presented with the know-how, information of average physical build in the region where of the work site is located, or the like. In other words, there has been room for improvement in know-how presentation technology. Now, know-how refers to specific or specialized knowledge, technology, techniques, and information, and is typically communicated through explanation using words, images, actions, and so forth. Examples of know-how include, but are not limited to, tasks such as screwing, assembly, and so forth, operating applications or software, and business operation procedures and the like.

In view of the above circumstances, an object of the present disclosure is to improve know-how presentation technology.

A know-how presentation method according to an embodiment of the present disclosure is
a know-how presentation method executed by an information processing device, the method including
acquiring a request for output of know-how,
acquiring region information, and
adjusting contents of the know-how corresponding to the request, based on the region information, and outputting the know-how of which the contents are adjusted.

According to an embodiment of the present disclosure, know-how presentation technology is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure; and

FIG. 2 is a flowchart showing operations of an information processing device.

### DETAILED DESCRIPTION OF EMBODIMENTS

An embodiment of the present disclosure will be described below.

### Outline of Embodiment

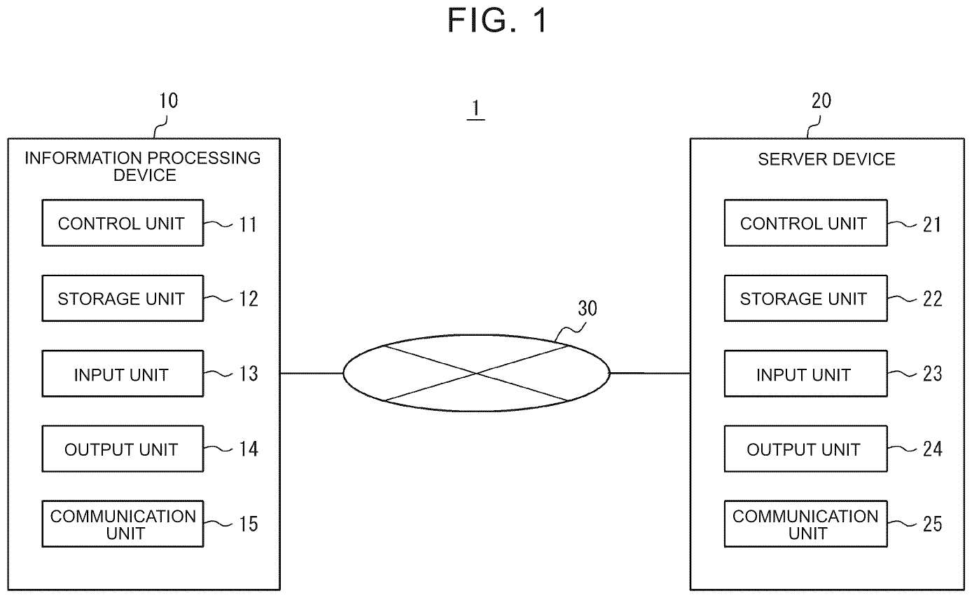

An outline and a configuration of a system 1 according to the present embodiment will be described with reference to FIG. 1. The system 1 according to the present embodiment includes an information processing device 10 and a server device 20. The information processing device 10 is any device that is used by each of users. For example, general-purpose electronic equipment such as personal computers, smartphones, tablet terminals, wearable terminals, and so forth, or dedicated electronic equipment, can be employed as the information processing device 10. The server device 20 is a server device that is installed in, for example, a data center or the like. The server device 20 is, for example, a server belonging to a cloud computing system or some other computing system. The server device 20 includes a language model. In the present embodiment, the language model includes any dialogue system, such as a Large Language Model (LLM) a chatbot, or the like. Based on the input of a prompt, which is an instruction from a user, the language model outputs text corresponding to the prompt. For example, the information processing device 10 inputs a prompt into the language model of the server device 20 and acquires an output result corresponding to the prompt. The information processing device 10 and the server device 20 are communicatively connected to a network 30 including, for example, a mobile communication network, the Internet, and so forth. Note that while FIG. 1 illustrates one each of the information processing device 10 and the server device 20, the system 1 may include a plurality of such devices.

First, the outline of the present embodiment will be described, and the details will be described later. First, the information processing device 10 acquires a request for output of know-how. The information processing device 10 acquires know-how corresponding to the request. The information processing device 10 also acquires region information. The information processing device 10 adjusts contents of the know-how corresponding to the request, in accordance with the region information. The information processing device 10 outputs the know-how of which the contents have been adjusted.

In this way, according to the present embodiment, the region information is acquired, and know-how of which the contents have been adjusted based on situation information is output. This improves the know-how presentation technology in that the probability of outputting know-how taking region information into consideration will increase.

Next, each of the configurations of the information processing device 10 and the server device 20 will be described in detail. As illustrated in FIG. 1, the information processing device 10 includes a control unit 11, a storage unit 12, an input unit 13, an output unit 14, and a communication unit 15. The control unit 11 includes at least one processor. The processor is a general-purpose processor such as a central processing unit (CPU) or the like, or a dedicated processor that is specialized for specific processing. The control unit 11 executes processing related to operations of the information processing device 10, while controlling the units of the information processing device 10. The storage unit 12 includes at least one semiconductor memory or the like. The semiconductor memory is, for example, random access memory (RAM) or read-only memory (ROM). The storage unit 12 functions as, for example, a main storage device or an auxiliary storage device. The storage unit 12 stores data that is used for the operations of the information processing device 10 and data that is acquired through the operations of the information processing device 10. For example, the storage unit 12 stores a learning model. A learning model is a model that is created by machine learning using a machine learning algorithm. The learning model may be, for example, a machine learning model that is constructed based on a decision tree, or a model that is generated based on a machine learning algorithm such as a convolutional neural network (CNN), a recurrent neural network (RNN), or some other type of deep learning or the like. The input unit 13 includes at least one input interface. The input interface may be, for example, physical keys, a touchscreen display, a sound sensor that accepts speech input, a camera that accepts gesture input, or the like. The input unit 13 receives operations for inputting data to be used for operations of the information processing device 10. The output unit 14 includes at least one output interface. The output interface is, for example, a display that outputs information as video, a speaker that outputs information as audio, or the like. The output unit 14 outputs data that is obtained by the operations of the information processing device 10. The communication unit 15 includes at least one external communication interface. The communication interface may be an interface for either wired communication or wireless communication. In the case of wired communication, the communication interface is, for example, a local area network (LAN) interface or a Universal Serial Bus (USB) interface. In the case of wireless communication, the communication interface is, for example, an interface compatible with mobile communication standards such as 5G or the like, or an interface that is compatible with near-field communication. The communication unit 15 receives data that is used for the operations of the information processing device 10, and also transmits data that is acquired through the operations of the information processing device 10.

Also, as illustrated in FIG. 1, the server device 20 includes a control unit 21, a storage unit 22, an input unit 23, an output unit 24, and a communication unit 25. The control unit 21 includes at least one processor. The processor is a general-purpose processor such as a CPU or the like, or a dedicated processor that is specialized for specific processing. The control unit 21 executes processing related to the operations of the server device 20 while controlling each unit of the server device 20. The storage unit 22 includes at least one semiconductor memory or the like. The semiconductor memory is, for example, RAM or ROM. The storage unit 22 functions as, for example, a main storage device, an auxiliary storage device, or the like. The storage unit 22 stores data that is used in the operations of the server device 20 and data that is obtained by the operations of the server device 20. The input unit 23 includes at least one input interface. The input interface may be, for example, physical keys, a touchscreen display, a sound sensor that accepts speech input, a camera that accepts gesture input, or the like. The input unit 23 accepts operations for inputting data to be used for the operations of the server device 20. The output unit 24 includes at least one output interface. The output interface is, for example, a display that outputs information as video, a speaker that outputs information as audio, or the like. The output unit 24 outputs data that is obtained by the operations of the server device 20. The communication unit 25 includes at least one external communication interface. The communication interface may be an interface for either wired communication or wireless communication. In the case of wired communication, the communication interface is, for example, a LAN interface or a USB interface. In the case of wireless communication, the communication interface is, for example, an interface compatible with mobile communication standards such as 5G or the like, or an interface that is compatible with near-field communication. The communication unit 25 receives data that is used in the operations of the server device 20, and also transmits data that is obtained by the operations of the server device 20.

Functions of the information processing device 10 or the server device 20 are realized by executing a program according to the present embodiment in a processor corresponding to the control unit 11 or the control unit 21. That is to say, the functions of the information processing device 10 or the server device 20 are realized by software. The program causes a computer to execute the operations of the information processing device 10 or the server device 20, thereby causing the computer to function as the information processing device 10 or the server device 20. That is to say, the computer functions as the information processing device 10 or the server device 20 by executing the operations of the information processing device 10 or the server device 20 in accordance with the program. In the present embodiment, the program can be recorded in a computer-readable recording medium. The computer-readable recording medium includes non-transitory computer-readable media, and is, for example, magnetic recording devices, semiconductor memory, and the like. Distribution of the program is carried out by, for example, selling, transferring, or leasing a portable recording medium such as a digital versatile disc (DVD) or the like in which the program is recorded. Also, the distribution of the program may be performed by storing the program in storage of an external server and transmitting the program from the external server to another computer. Further, the program may be provided as a program product. Part or all of the functions of the information processing device 10 or the server device 20 may be realized by a dedicated circuit corresponding to the control unit 11 or the control unit 21. That is to say, part or all of the functions of the information processing device 10 or the server device 20 may be realized by hardware.

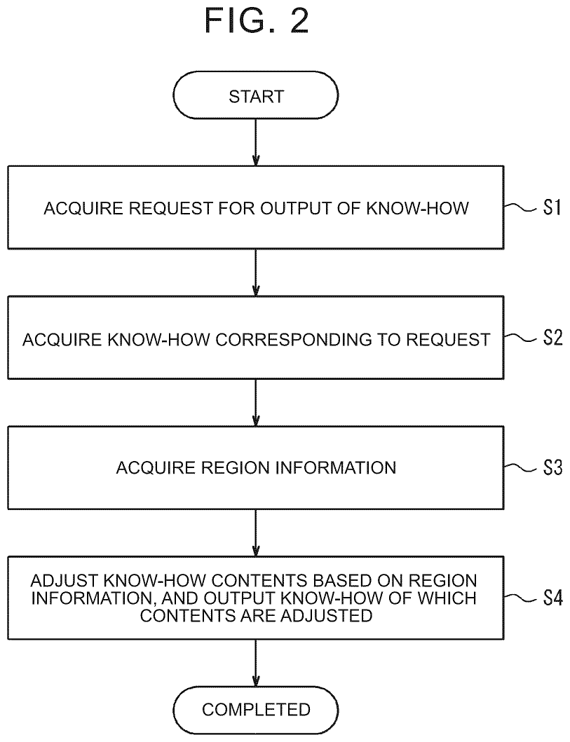

The operations of the information processing device 10 according to the present embodiment will be described with reference to FIG. 2. First, the control unit 11 of the information processing device 10 acquires a request for outputting know-how (step S1). Any technique can be employed to acquire requests for outputting know-how. For example, the control unit 11 may acquire the request based on an input operation by the user on the input unit 13. Any user interface can be employed for this input operation. For example, the input unit 13 may receive a prompt corresponding to a request from a user through a key input operation, a voice input operation, a touch panel operation, a gesture input, or the like.

Next, the control unit 11 acquires know-how corresponding to the request (step S2). Any technique can be employed to acquire know-how corresponding to a request. For example, the control unit 11 transmits a prompt corresponding to the request to the server device 20 via the communication unit 15 and inputs the prompt into the language model of the server device 20. The language model of the server device 20 outputs know-how corresponding to the prompt. The control unit 11 acquires the know-how via the communication unit 15. In this way, the control unit 11 may acquire know-how corresponding to the request by using the language model of the server device 20.

Next, the control unit 11 acquires region information corresponding to the user that transmitted the request (step S3). The region information may be information indicating the location of the user, the country or region where the user is from, or the country or region of the company or organization to which the user belongs. For example, the region information includes at least one of environmental information regarding the work site of the user that sent the request, and average physical build information for the work region of the user. The environmental information includes at least one of weather information, location information, and time of day in the work region. The weather information includes at least one of temperature, humidity, precipitation, wind speed, wind direction, and atmospheric pressure. Any technique can be employed to acquire the region information. For example, the region information may be acquired from an external database. The external database may be provided in the server device 20, or may be provided in another external device.

The control unit 11 adjusts the contents of the know-how based on the region information and outputs the know-how of which the contents are adjusted (step S4). Any technique can be employed to adjust the contents of the know-how. For example, the know-how may include work processes, and the adjustment of the know-how may include changes in the work processes. For example, an assumption will be made that the work know-how for a region where the average physical build is large (hereinafter also referred to as “first region”) includes an action of “crouching”. In this case, when this know-how is applied to a region where the average physical build is smaller than that in the first region (hereinafter also referred to as “second region”), the control unit 11 adjusts the contents of the know-how based on the region information. Specifically, for example, the control unit 11 excludes the “crouching” action and optimizes the work to match the second region. More specifically, for example, the control unit 11 may optimize the work method by changing to working in a standing posture or the like, as a work method suitable for the second region instead. In other instances, work may be optimized by modifying handling of heavy loads, for example. Specifically, for example, when the work know-how for the first region includes a lifting action using one hand, the work know-how for the second region, where the average physical build is smaller, may be changed to a lifting action using both hands. Alternatively, the control unit 11 may recommend the use of aiding equipment (a crane, a forklift, or the like) in the second region. Additionally, the work may be optimized, for example, by changing the materials that are used or the like. For example, the control unit 11 may make adjustments such as changing the material to a material that takes thermal expansion into consideration in hot regions, or changing the material to a material that is resistant to rust and deterioration, or the like, in humid regions. Also, for example, when physical build and hand sizes differ, the control unit 11 may optimize work efficiency by adjusting the size, shape, and so forth of work tools, and selecting a tools that are easy to grip.

Any technique can be employed for outputting the adjusted know-how. For example, the control unit 11 may output the adjusted know-how through a user interface via the output unit 14 of the information processing device 10. Also, at this time, the control unit 11 may also output the basis and reasons for adjusting the contents of the know-how. For example, when the contents of the know-how are adjusted based on the average physical build information, the control unit 11 may output the average physical build information as the basis and reasons through a user interface via the output unit 14.

As described above, the information processing device 10 according to the present embodiment acquires a request for outputting know-how, and acquires know-how corresponding to the request. The information processing device 10 also acquires region information. The information processing device 10 adjusts contents of the know-how corresponding to the request, in accordance with the region information. The information processing device 10 outputs the know-how of which the contents have been adjusted.

According to this configuration, the information processing device 10 acquires situation information, and outputs know-how of which the contents have been adjusted based on this region information. This improves the know-how presentation technology in that the probability of outputting know-how taking region information into consideration will increase.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions and so forth that are included in the configurations, steps, and so forth, can be rearranged so as not to be logically inconsistent, and a plurality of configurations, steps, and so forth, can be combined into one or can be divided.

For example, the control unit 11 may execute appropriateness determination (employability determination) of the adjusted know-how. The appropriateness determination may be based on input of confirmation results by an experienced user, input of confirmation results by multiple users, or the like. Also, the appropriateness determination may also be based on restriction information such as local laws and regulations related to the region information.

Also, for example, in addition to the region information, the control unit 11 may acquire information related to individual situations or the like, such as the vital information, emotions, and so forth of the user (hereinafter, also referred to as “situation information”). The control unit 11 may also adjust the content of the know-how based on the situation information. Any technique may be employed to acquire the situation information. For example, the situational information may be acquired from an external sensor. The external sensor may be installed in a wearable device that is worn by the user, for example. Wearable devices may be used to measure biometric information such as heart rate, blood pressure, acceleration, skin potential, and so forth, and to comprehend the physiological condition of the user. Alternatively, the situation information may be acquired by external equipment such as a camera, a microphone, or the like. For example, a camera may shoot facial expressions, gaze, posture, and so forth of the user, and the level of tension, emotions, and intentions of the user, may be estimated based on these facial expressions. Also, for example, the tone of voice of the user, speech content, surrounding sounds, and so forth, may be acquired by a microphone, and the level of tension, emotions, and intentions of the user may be estimated based on this information. Further, the current location of the user, travel route thereof, and so forth, can be acquired using a Global Positioning System (GPS) device, a location information sensor, or the like, and this information can be used for situation recognition. Any technique can be employed to adjust the content of the know-how based on the situation information. For example, when the situation information includes the level of tension of the user, and the level of tension is equal to or greater than a predetermined value, the control unit 11 may fine-tune the content of the know-how by limiting the content of the know-how to only items with high priority. Specifically, the control unit 11 may facilitate understanding of the user by omitting complicated procedures, converting the procedures into visually easy-to-understand expressions using diagrams, tables, and so forth. Also, for example, when the situation information includes information regarding presence or absence of nearby people, the contents of the know-how may be adjusted by limiting the contents of the know-how to only items with high priority. For example, when there are people around, adjustments may be executed such as making the explanation more concise, or the like. Note that the contents of the know-how can be adjusted from various aspects, such as by adjusting the level of abstraction, granularity, and so forth, of the contents, changing the order of explanations, changing the method of expression, and so forth.

Also, for example, in the above-described embodiment, an embodiment can be made in which the configuration and the operations of the information processing device 10 are distributed among a plurality of computers including the server device 20, that are capable of communicating with each other.

What is claimed is:

1. A know-how presentation method executed by an information processing device, the know-how presentation method including:
acquiring a request for output of know-how;
acquiring region information; and
adjusting contents of the know-how corresponding to the request, based on the region information, and outputting the know-how of which the contents are adjusted.

2. The know-how presentation method according to claim 1, wherein the region information includes at least one of environmental information and average physical build information.

3. The know-how presentation method according to claim 2, wherein the environmental information includes at least one of weather information, location information, and time of day.

4. The know-how presentation method according to claim 3, wherein the weather information includes at least one of temperature, humidity, precipitation, wind speed, wind direction, and atmospheric pressure.

5. The know-how presentation method according to claim 1, wherein the know-how includes a work process, and the adjusting of the know-how includes change in the work process.
